(19) United States
(12) Patent Application Publication
(10) Pub. No.: US 2014/0156147 A1
(43) Pub. Date: Jun. 5, 2014

(54) EXTERNAL AIRBAG DEPLOYMENT METHOD AND SYSTEM

(71) Applicant: HYUNDAI MOTOR COMPANY, Seoul (KR)

(72) Inventors: Han Sung Lee, Seoul (KR); Seoung Hoon Lee, Suwon (KR); Yong Sun Kim, Namyangju (KR); Sang Min Jo, Jeonju (KR); Jin Ho Bae, Suwon (KR)

(73) Assignee: HYUNDAI MOTOR COMPANY, Seoul (KR)

(21) Appl. No.: 13/846,544

(22) Filed: Mar. 18, 2013

(30) Foreign Application Priority Data
Dec. 4, 2012 (KR) 10-2012-0139526

(51) Int. Cl. B60R 21/36

(52) U.S. Cl. CPC B60R 21/36
USPC 701/45

(57) ABSTRACT

Disclosed herein is an external airbag deployment system and method. The method includes determining, by a controller, whether to deploy an external airbag. The controller may be configured to set a detection area having a predetermined range and track physical characteristics of objects entering the detection area to update the physical characteristics at intervals of a measurement period of a front sensor. In addition, the controller may be configured to calculate predicted physical characteristics at intervals of a unit time during each measurement period. Based on the calculated physical characteristics, the controller may be configured to determine whether to deploy the external airbag at intervals of the unit time.

### CROSS-REFERENCE TO RELATED APPLICATION

This application claims under 35 U.S.C. §119(a) the benefit of Korean Patent Application No. 10-2012-0139526 filed on Dec. 4, 2012 the entire contents of which are incorporated herein by reference.

### BACKGROUND OF THE INVENTION

1. Field of the Invention

The present invention relates, in general, to an external air bag deployment method, for a vehicle, which is configured to predict a potential collision and deploy an external airbag at time of the collision based on the results of the prediction, without causing false operation.

More particularly, the present invention relates to an external airbag deployment method, which predicts and obtains the physical characteristics of objects at intervals of a unit time, and which determines whether to deploy an external airbag based on the predicted and obtained physical characteristics, thus deploying the external airbag in a high-speed collision or a sudden collision.

2. Description of the Related Art

Recently, an external airbag that is outwardly deployed from the front or rear side of a vehicle has been developed and presented as a technology for improving the vehicle safety. This technology is configured to deploy an external airbag by detecting and predicting a vehicle collision. However, in this technology maximum shock absorption effects must be obtained by deploying the external airbag at a precise time of the collision, and stability must be improved by correctly deploying the external airbag at a time point at which the airbag must be deployed, and system reliability must be improved by preventing the airbag from being falsely deployed at a time point at which the airbag must not be deployed.

A conventional method of controlling an airbag module using information obtained prior to a collision includes detecting information regarding an object located in front of a vehicle using an ultrasonic sensor and radar sensor mounted in the vehicle; comparing information regarding a distance to the object detected by the ultrasonic sensor with information about a distance to the object detected by the radar sensor; selecting at least one of the information regarding the object detected by the ultrasonic sensor and the information regarding the same object detected by the radar sensor based on the results of the comparison of the distance information, and determining whether the object is located in an area when there is a possibility that the object may collide with the vehicle, based on the selected information; and the fourth step of deploying an airbag module installed within the vehicle, based on the results of the determination of whether the object is located in the area where there is a possibility that the object may collide with the vehicle.

The foregoing is intended merely to aid in the better understanding of the background of the present invention, and is not intended to mean that the present invention falls within the purview of the related art that is already known to those skilled in the art.

### SUMMARY

Accordingly, the present invention provides an external airbag deployment method, which is implemented in a vehicle and is configured to predict a potential collision and deploy an external airbag at a substantially precise time based on the results of the prediction, without causing false operation.

The present invention provides an external airbag deployment method including setting a detection area located in front of a vehicle; updating physical characteristics of objects detected in the detection area at intervals of a measurement period of a front sensor, and calculating predicted physical characteristics at intervals of a unit time during each measurement period; selecting a target object from the objects detected in the detection area by comparing a relative velocity, an overlap, and a Time To External Airbag (EAB)(FIE) (e.g., the calculated physical characteristics), wherein the TIE is a remaining time until each object collides with an airbag cushion when the external airbag is predicted to be deployed; and deploying the external airbag when a relative velocity and an overlap, predicted at a time when the target object is predicted to collide with the vehicle, are greater than predetermined levels.

Furthermore, setting the detection area may include assigning Identifications (IDs) to respective detected objects and managing the detected objects. Additionally, the unit time may be 1 ms, and when measurement is performed at time i by the front sensor, the process may include calculating a physical characteristic at time i+1 using a tracking filter such as an alpha-beta filter and a Kalman filter, and calculating physical characteristics using previous physical characteristics during an interval from the time i+1 to a subsequent measurement period.

Moreover, the process may include calculating displacement by adding a value, obtained by multiplying a unit time by a velocity obtained at a previous step, to displacement obtained at the previous step, upon calculating physical characteristics during an interval from time i+1 to a subsequent measurement period. In addition, a velocity may be calculated from a velocity obtained at a previous step using an acceleration at time i, upon calculating physical characteristics during an interval from time i+1 to a subsequent measurement period. The process may further include calculating a TTE, which is a remaining time until an object collides with an airbag cushion when the external airbag is predicted to be deployed, by dividing a value, obtained by subtracting a thickness of the airbag cushion from a relative distance at a corresponding time point, by a relative velocity at the corresponding time point, upon calculating physical characteristics during the interval from the time i+1 to the subsequent measurement period.

Further, the present invention provides an external airbag deployment method of determining whether to deploy an external airbag, wherein a detection area having a predetermined range may be set, physical characteristics of objects entering the detection area may be tracked to update the physical characteristics at intervals of a measurement period of a front sensor and predicted physical characteristics may be calculated at intervals of a unit time during each measurement period, and based on the calculated physical characteristics whether to deploy the external airbag at intervals of the unit time may be determined.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary flowchart showing an external airbag deployment method according to an exemplary embodiment of the present invention;

FIGS. 2 and 3 are exemplary diagrams showing the detection area of the external airbag deployment method according to an exemplary embodiment of the present invention;

FIG. 4 is an exemplary diagram showing the prediction procedure of the external airbag deployment method according to an exemplary embodiment of the present invention;

FIG. 5 is an exemplary diagram showing the overlap determination of the external airbag deployment method according to an exemplary embodiment of the present invention;

FIGS. 6 and 7 are exemplary diagrams showing TIC and TIE of the external airbag deployment method according to an exemplary embodiment of the present invention;

FIG. 8 is an exemplary diagram showing the stability determination step of the external airbag deployment method according to an exemplary embodiment of the present invention;

FIGS. 9 and 10 are exemplary diagrams showing the prediction step of the external airbag deployment method according to an exemplary embodiment of the present invention; and

FIGS. 11 to 13 are exemplary diagrams showing the avoidance step of the external airbag deployment method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, embodiments of an external airbag deployment method according to the present invention will be described in detail with reference to the attached drawings.

Reference now should be made to the drawings, in which the same reference numerals are used throughout the different drawings to designate the same or similar components.

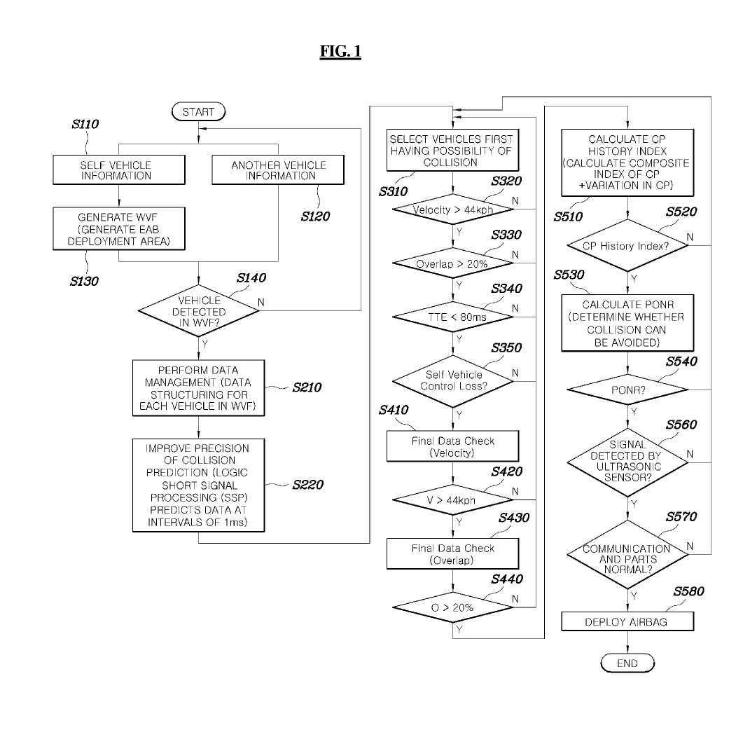

FIG. 1 is an exemplary flowchart showing an external airbag deployment method according to an exemplary embodiment of the present invention. The external airbag deployment method according to the present invention may include setting, by a controller, a detection area located in front of a vehicle; updating, by the controller, the physical characteristics of objects detected in the detection area at intervals of the measurement period of a front sensor; calculating, by the controller, predicted physical characteristics at intervals of a unit time during each measurement period; selecting, by the controller, a target object (e.g., a target vehicle) from the objects detected in the detection area by comparing a relative velocity, an overlap, and a Time To External Airbag (EAB) (TTE), calculated as the physical characteristics, wherein the TTE is the remaining time until each object collides with an airbag cushion at a time when the external airbag is predicted to be deployed; and deploying the external airbag when a relative velocity and an overlap, predicted at a time when the target object is predicted to collide with the vehicle, are greater than predetermined levels.

The present invention relates to an external airbag deployment method and system, which may be configured to determine whether to deploy an external airbag when tracking the physical characteristics of detected objects while updating the physical characteristics using the front sensor.

First, an overall embodiment of the external airbag deployment method according to the present invention will be described below. Information regarding an autonomous vehicle may be obtained, and information regarding another object may be obtained at steps S110 and S120. Furthermore, the information may be obtained using sensors for measuring the physical characteristic of the autonomous vehicle. The information may be measured using sensors, such as a laser sensor, a radar sensor, and an imaging device in the autonomous vehicle.

In detail, the information regarding the autonomous vehicle obtained by the sensors is given as follows in Table 1.

TABLE 1

| Sensor | No | Information transferred to ACU |
|---|---|---|
| Vehicle velocity sensor | 1 | FL(Front left) wheel speed |
| | 2 | FR (Front right) wheel speed |
| | 3 | RL (Rear Left) wheel speed |
| | 4 | RR (Rear Right) wheel speed |
| Brake sensor | 5 | M/Cylinder pressure (MPa) |
| | 6 | Wheel slip ratio |
| | 7 | |
| | 8 | |
| Acceleration sensor | 9 | Longitudinal acceleration |
| | 10 | Lateral acceleration |
| Yaw rate sensor | 11 | Yaw rate (rad/sec) |
| | 12 | |
| Wheel angle sensor | 13 | Steering wheel angle |
| | 14 | |

Additionally, information regarding another object, obtained by the sensors, is given as follows in Table 2.

TABLE 2

| Sensor | No | Information transferred to ACU |
|---|---|---|
| Radar(40 ms) | 1 | Relative velocity |
| | 2 | Relative distance |
| | 3 | Longitudinal position |
| | 4 | Lateral position |
| | 5 | Tracking ID |
| | 6 | TTC (time to collision) |
| Camera (80 ms) | 7 | Classification information |
| | 8 | Object width |
| | 9 | Longitudinal position |
| | 10 | Lateral position |
| | 11 | |
| | 12 | |
| | 13 | |
| | 14 | |
| Ultrasonic (10 ms) | 15 | Relative distance |
| | 16 | |

TABLE 3

| No | Information transferred to ACU |
|---|---|
| 1 | Object ID |
| 2 | Position X |
| 3 | Position Y |
| 4 | Velocity X |
| 5 | Velocity Y |
| 6 | Object age |
| 7 | Object prediction age |
| 8 | Object time offset |
| 9 | Object classification |

Furthermore, the information obtained by the sensors, may be sent to a controller disposed in the autonomous vehicle, as shown in Table 3, to obtain relative information and absolute information regarding the autonomous vehicle and another object. All of the relative and absolute information may be used in the following procedure.

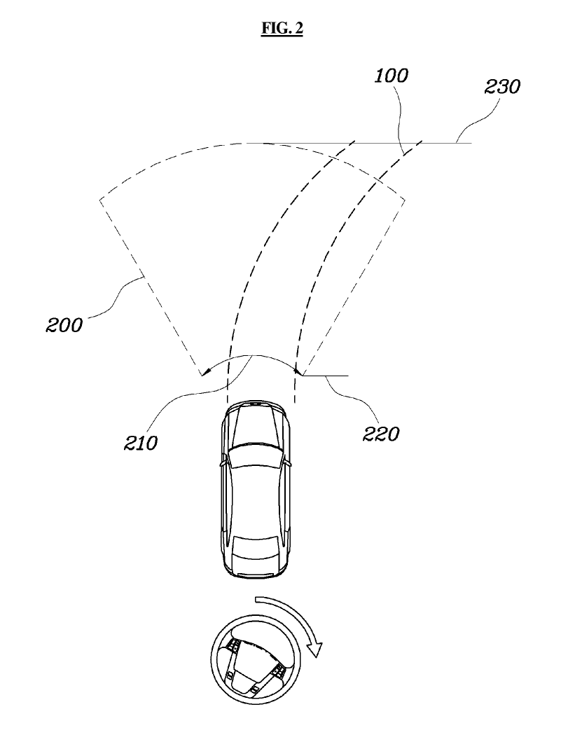

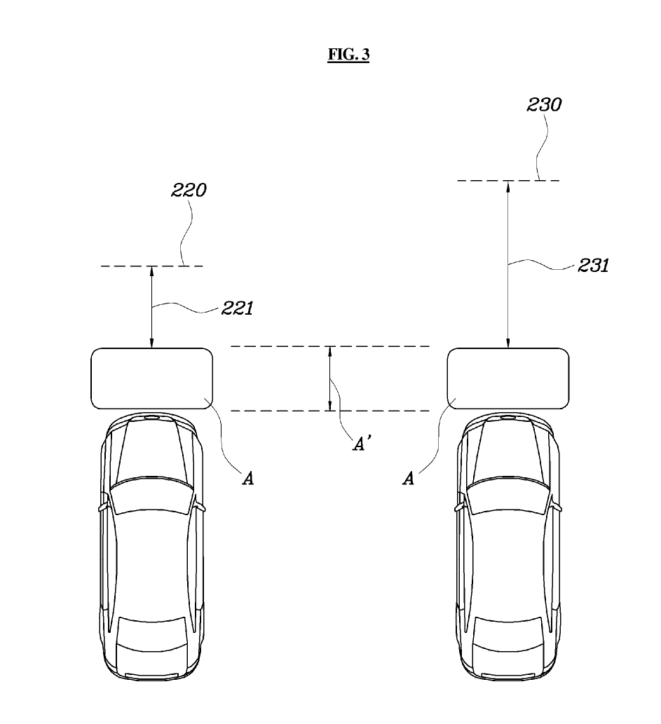

Further, the process of setting (S130), by the controller, the detection area located in front of the vehicle (also referred to as a Wide Vehicle Funnel: WVF) may be performed. As shown in FIG. 2, the process may include setting a basic area 100 which is moved to correspond with the steering movement of the vehicle, and a real area 200 in which the time of the external airbag of the vehicle and the velocity of the vehicle are considered.

In particular, the basic area may be obtained by calculating a radius of rotation of the vehicle using a vehicle width and a steering angle and by offsetting the radius of rotation to opposite sides of the vehicle. Such a radius of rotation of the vehicle may be calculated by the following Equation (1):

$$ρ = \frac{W}{2} \cdot \frac{{W}_{RL} - {W}_{RR}}{{W}_{RL} + {W}_{RR}} , \\ ( calculation of radius of rotation ) \qquad ( 1 )$$

when W denotes the wheel base of the vehicle, and W_{RX} denotes the wheel speed of the vehicle.

Further, the fan shaped real area may be set based on the relative velocity of the vehicle and the deployment time of the external airbag. In other words, when the time required to fully deploy the external airbag is predicted to be 65 ms, the limit of a minimum real area may be obtained based on the time during which the cushion of the airbag is fully deployed at the minimum relative velocity. When the vehicle is protected by deploying the external airbag in a collision occurring at a relative velocity of a minimum of 44 km/h, a separation distance may be calculated at a relative velocity based on a time of 65 ms which is a minimum time required to deploy the external airbag, and the thickness of the airbag may be added to the separation distance, to obtain the limit of the real area that must be considered to be a minimum.

In other words, the minimum value of the real area may be calculated as 1.5 m which is obtained by adding 0.7 m (e.g., the thickness of the airbag) to 0.8 m (e.g., a distance based on a relative velocity of 44 km/h and a time of 65 ms), that is, 0.7 m+0.8 m.

Further, the maximum value of the real area may be calculated as a value which is obtained by adding 0.7 m (e.g., the thickness of the airbag) to 2.9 m (e.g., a distance based on a maximum relative velocity of 160 km/h and a time of 65 ms), that is, 0.7 m+2.9 m, when the external airbag is deployed in a collision having a maximum relative velocity of 160 km/h.

However, above indicates that a vehicle velocity is substantially high, wherein such a deployment operation may be possible only when a minimum recognition time required by a sensor, such as an imaging device, to identify an object, a time required by the sensor to sample measured values, and a time corresponding to the number of sampling times are additionally secured. Therefore, when the maximum value, 8.9 m which is a distance based on an imaging device determination time of 200 ms and a relative velocity of 160 km/h and 8.9 m which is a distance based on a time of 200 ms during which sampling at a sampling time of 40 ms may be performed five times and a relative velocity of 160 km/h, are additionally required, and as a result, a maximum value of 21.4 m may be required.

Therefore, another object may be searched for in an area spaced apart from the front of the vehicle by at least 1.5 m, and then the airbag can be deployed. Further, another object may be searched for in an area spaced apart from the front of the vehicle by a maximum of 21.4 m, and then the airbag may be deployed.

In particular, other objects may be detected in a range in which the basic area and the real area overlap each other. However, when other objects are present both in the basic area and in the detection area, an object detected to be the closest to the vehicle may be set as a target object. Alternatively when only 10 objects may be covered and tracked in the real area, and 12 objects are detected, a criterion for elimination may be utilized to eliminate other objects detected in a section in which the basic area and the real area do not overlap each other.

Moreover, when any object is detected in such a detection area, such an object may be called a detected object at step S140. The physical characteristics of detected objects may be measured by a laser sensor or a radar sensor, and the type of the detected objects can be determined by a imaging device sensor. Further, identifications (IDs) may be assigned to the respective detected objects, and the relative physical quantities of the detected objects based on the IDs may be sensed and continuously updated.

In other words, the process may further include recognizing (S210), by the controller, detected objects in the detection area and assigning IDs to the detected objects, and updating, by the detected objects when measurement is performed by a front sensor.

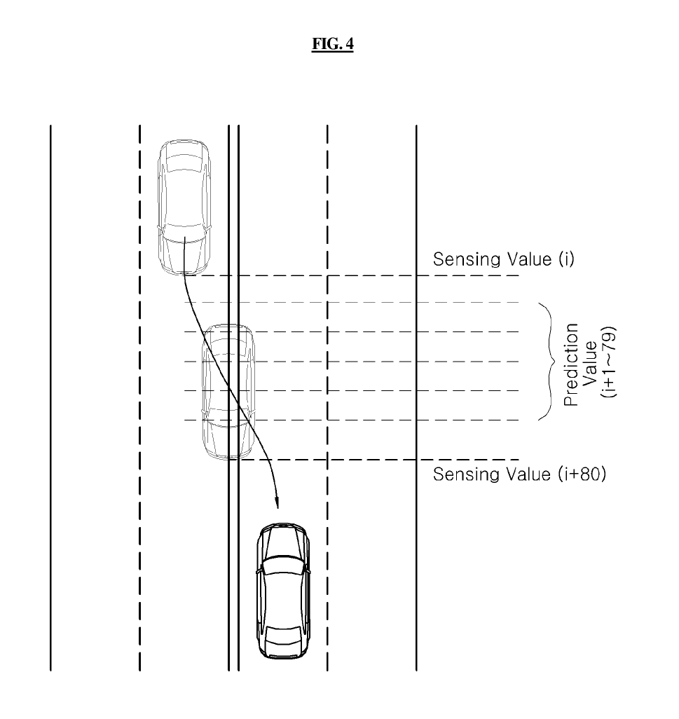

Moreover, the measurement periods of the respective sensors may vary. In other words, as shown in FIG. 4 which is a diagram showing the prediction procedure of the external airbag deployment method according to an embodiment of the present invention, the process may include updating, by the controller, data regarding detected objects and a target object at intervals of the measurement period of the front sensor, and calculating, by the controller, predicted data at intervals of a predetermined time during each measurement period, wherein the data may be used as data regarding the detected objects and the target object. In the present invention, the unit time may be set to 1 ms, thus increasing the precision of deployment determination and validating determination even in a high-speed collision situation.

Moreover, when measurement is performed at time i by a front sensor, the process may include calculating, by the controller, a physical characteristic at time i+1 using a tracking filter such as an alpha-beta filter and a Kalman filter, and calculating physical characteristics using previous physical characteristics (e.g., previously calculated characteristics) during an interval ranging from the time i+1 to a subsequent measurement period.

In other words, when the measurement period of the sensor is 80 ms, data is may not be provided during the measurement period of 80 ms. Therefore, the measured values may be updated at intervals of 80 ms which is the measurement period, but updated values may be predicted at intervals of 1 ms even during the measurement period.

For the above operation, as shown in the drawing, when the measurement by the sensor is performed at time i, a value at time i+1 may be obtained using the value obtained at time i. The values may be obtained using a well-known tracking filter, such as an alpha-beta filter or a Kalman filter. Thereafter, the controller may be configured to calculate displacement by adding a value, obtained by multiplying a unit time by a velocity previously obtained, to displacement previously obtained, upon calculating physical characteristics during the interval from the time i+1 to the subsequent measurement period. Further, the controller may be configured to calculate a velocity from a velocity previously obtained using an acceleration at the time i, upon calculating physical characteristics during the interval from the time i+1 to the subsequent measurement period.

Moreover, the process may include, calculating, by the processor, a 11E, which is the remaining time until an object collides with an airbag cushion when the external airbag is predicted to be deployed, by dividing a value, obtained by subtracting the thickness of the airbag cushion from a relative distance at the corresponding time point, by a relative velocity at the corresponding time point, upon calculating physical characteristics during the interval from the time i+1 to the subsequent measurement period. In particular, at times ranging from i+1 to i+79, updating may be performed using individual values. This procedure may be understood by the following Equation (2):

\hat{x}ᵢ₊₂=\hat{x}ᵢ₊₁+ΔT\hat{v}ᵢ₊₁

\hat{v}ᵢ₊₂=\hat{v}ᵢ₊₁+ΔTaₛ, TTE=(\hat{x}ᵢ₊₂−0.7)/\hat{v}ᵢ₊₂

(ΔT=1 ms, aₛ: Self Vehicle Acceleration) (2)

As described above, a subsequent position may be obtained using a previous position and a previous velocity, and a subsequent velocity may be continuously estimated using current acceleration, that is, acceleration at a time point at which the sensor performs measurement. Since this measurement may be performed for a substantially short time, the range of error may decrease even when a subsequent velocity is calculated using the current acceleration. Further, time TTE may be obtained by subtracting 0.7 m which is the thickness of the airbag from a relative distance and by dividing the subtracted result value by a velocity, at intervals of a predetermined time, that is, 1 ms.

Moreover, the process may include selecting (S310), by the controller, an object having the shortest Time To EAB (TIE), from the detected objects in the detection area, as a dangerous object, wherein the TTE is the remaining time until the airbag cushion collides with the object when the external airbag is predicted to be deployed. Alternatively, the controller may be configured to select an object having the shortest Time To Collision (TTC), from the detected objects in the detection area, as a dangerous object, wherein the TTC is the remaining time until the object collides with the vehicle when the vehicle collision is predicted to occur. In other words, from the objects detected in the detection area, an object having the shortest TTE or TIC may be selected as a dangerous object.

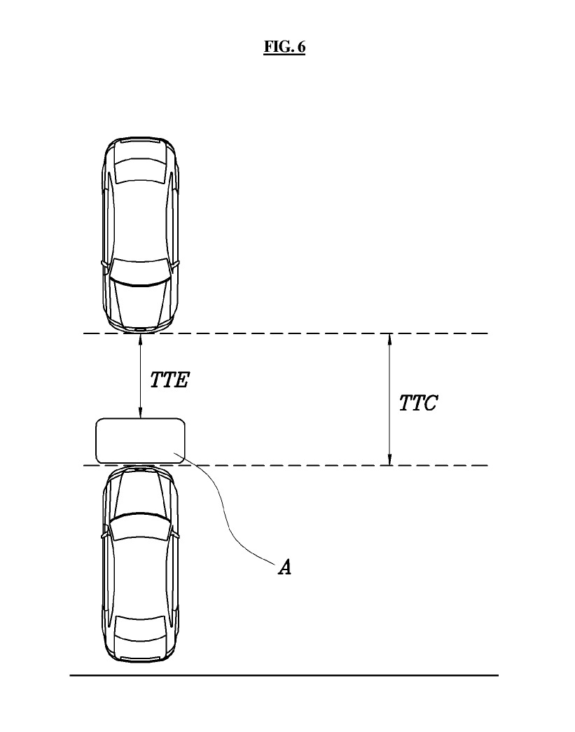

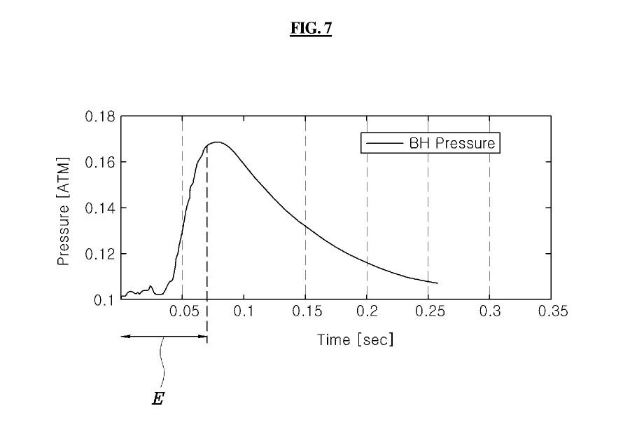

FIGS. 6 and 7 are exemplary diagrams showing TTC and TTE of the external airbag deployment method according to an exemplary embodiment of the present invention. A TTE denotes the remaining time until an object collides with an airbag cushion when the external airbag is predicted to be deployed, and a TTC denotes the remaining time until the object collides with the vehicle when the vehicle collision is predicted to occur.

In other words, as shown in FIG. 6, when the airbag is predicted to be deployed, a TTE denotes a time during which an object collides with the airbag substantially immediately when the airbag may be fully deployed. As shown in FIG. 7, as time elapses during the deployment of the airbag, the pressure of the cushion may increase, the pressure may reach a maximum when the airbag is fully deployed, and the pressure may decrease after full deployment. To cause the object to collide with the airbag when the airbag is fully deployed, a time TTE may be introduced. Therefore, the TTE may be obtained from the distance of the current object, and the maximum shock absorption performance may be obtained when the airbag is deployed for the obtained time TIE.

Additionally, a TTC denotes the remaining time until an object collides with the bumper of a vehicle, and is a concept frequently utilized in a conventional internal airbag mounted in the vehicle. Therefore, in an autonomous vehicle, an object having the shortest TTC, which is the remaining time until the object collides with the vehicle when a collision with the vehicle is predicted to occur, may be selected from a plurality of objects detected in the detection area as a dangerous object. Alternatively, an object having the shortest TTE or TIC may be selected from the objects detected in the detection area as a dangerous object.

Furthermore, as will be described below, the controller may be configured to determine whether to deploy the airbag while the dangerous object is monitored. In other words, when the relative velocity of the dangerous object is greater than a first reference at step S320, an overlap is greater than a second reference at step S330, and a TTE is less than a third reference at step S340, the controller may be configured to select the dangerous object as a target object.

First, the relative velocity of the dangerous object may be monitored. Further, the relative velocity may be greater than a minimum of 44 km/h as the first reference since the minimum relative velocity, at which the vehicle must be protected in a collision with the dangerous object, is 44 km/h.

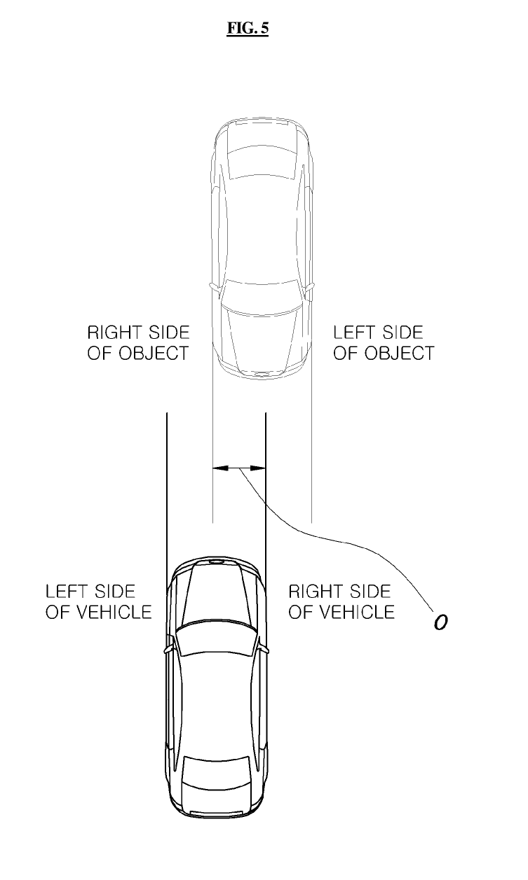

Furthermore, the overlap of the dangerous object with the vehicle may be greater than 20% as the second reference. As shown in FIG. 5, the greater of the left boundary value of a vehicle and the right boundary value of an object may be selected, and the smaller of the right boundary value of the vehicle and the left boundary value of the object may be selected. Then, the values between the selected boundary values may be considered to be an overlap distance, and the overlap distance may be divided by the width of the vehicle, and thereafter the divided result value may be multiplied by 100 and to be represented as a percentage. Therefore, when an object recognized as the dangerous object has a substantially high relative velocity and a substantially large overlap, the object may be selected as the target object.

Furthermore, the dangerous object may be selected as a target object when a TIE is less than the third reference since when the dangerous object has a substantially high relative velocity, a substantially large overlap, and a substantially short collision time, the dangerous object may be an object having an increased risk of collision.

Moreover, after the above procedure, the process may include determining (S350), by the controller, whether the vehicle is stable by comparing the predicted yaw rate of the vehicle with a measured yaw rate. In other words, the controller may be configured to determine whether the driving stability of the autonomous vehicle may be maintained by considering the vehicle to be an object having a two-degree-of-freedom. In particular, when a difference between the actual yaw rate of the vehicle and the predicted yaw rate is greater than a predetermined level, it the controller may be configured to determine that the vehicle is unstable. This technology is frequently utilized in conventional vehicle posture maintenance technology, that is, Electronic Stability Program (ESP) or the like, and thus a detailed description thereof will be omitted here.

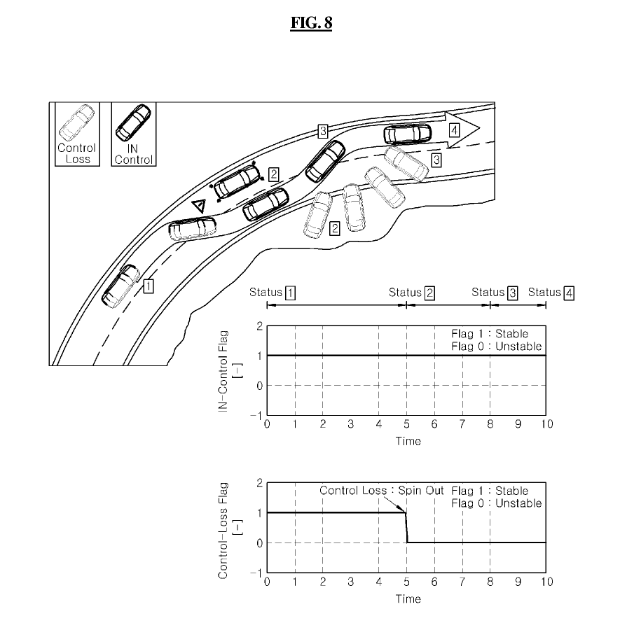

FIG. 8 is an exemplary diagram showing the stability determination step of the external airbag deployment method according to an exemplary embodiment of the present invention. In FIG. 8, flag 1 indicates a state when the vehicle is driven in a condition of maintaining traction stability, and the process proceeds to a situation in which the external airbag may be deployed. When traction stability is lost, as indicted by flag 0 in FIG. 8, the external airbag may not be deployed. Therefore, the external airbag may be deployed during unstable driving conditions.

Thereafter, the steps S410, S420, S430, and S440 of determining whether a relative velocity and an overlap, predicted when a vehicle collision is predicted to occur, are greater than predetermined levels may be performed. Further, the predetermined levels at the prediction step and the deployment step may be the first reference in case of the relative velocity and may be the second reference for the overlap.

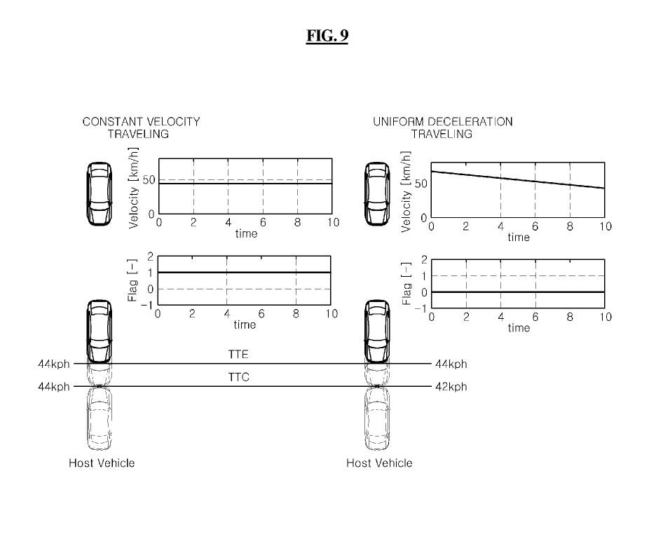

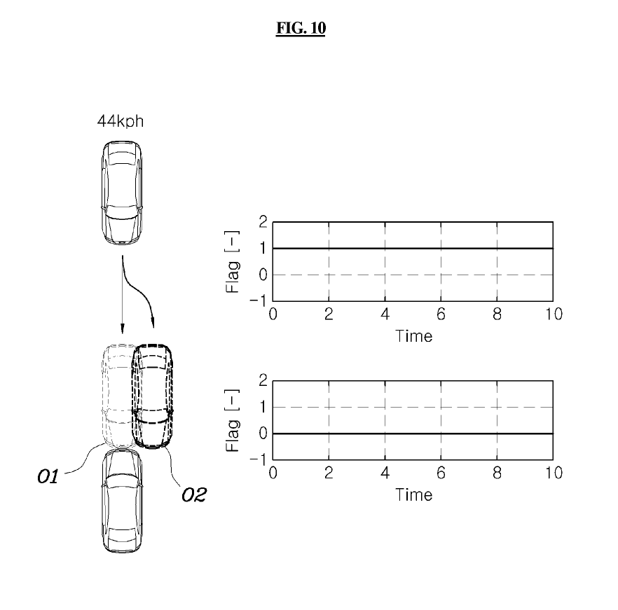

FIGS. 9 and 10 are exemplary diagrams showing the prediction step of the external airbag deployment method according to an exemplary embodiment of the present invention. In FIGS. 9 and 10, when an autonomous vehicle and a target object are traveling at constant velocity, the relative velocity may be maintained to be greater than the first reference. However, when the vehicle and the target object are traveling while decelerating, the velocity may decrease to a velocity of 42 km/h lower than the first reference (e.g., 44 km/h). Thus, the external airbag need not be deployed.

Therefore, even when the current relative velocity of the target object exceeds a minimum reference value of 44 km/h, when a predicted value at the collision time does not exceed 44 km/h, the airbag may not be deployed. Furthermore, the above situation may be shown by obtaining the mean of relative velocities obtained for a predetermined period of time, dividing the mean by time to obtain a relative acceleration, predicting a relative velocity at a TIC based on the relative acceleration, and then tracking the target object.

Further, when an overlap, as shown in FIG. 10, appearing at a time TTC, that is, at the time of collision, is predicted, and whether an actual collision will occur at an overlap of 20% or more may be predicted. Similarly, an overlap may be predicted by obtaining the mean of lateral relative velocities obtained to a current time, and tracking a lateral relative displacement at a time TTC based on the mean.

Therefore, the present invention may prevent false deployment of the external airbag by preventing the external airbag from being deployed when the relative velocity predicted at a TTC, that is, the time of a collision, does not exceed 44 km/h or when the overlap predicted at a TIC does not exceed 20% even when the current relative velocity exceeds 44 km/h and the current overlap exceeds 20%.

Further, when the predicted relative velocity and the predicted overlap of the target object are greater than the predetermined levels, and collision probability (CP) and a variation in CP are greater than predetermined levels, the external airbag may be deployed at steps S510 and S520. The collision probability (CP) may be defined by the following Equation (3):

$$C P = \frac{1}{T T C} \\ or \\ C P = \frac{Overlap}{T T C} \qquad ( 3 )$$

Therefore, a TTC may be obtained by the above equation, and CP may be obtained by taking a reciprocal of TTC or by multiplying the amount of overlap by the reciprocal of TTC. The actual CP may be considered to be substantially high when the obtained CP exceeds a predetermined value, causing the airbag to be deployed, thus preventing the false deployment of the airbag.

Further, the collision probability may be calculated at intervals of 1 ms, thus when the slope of the rate of a variation in CP is less than a predetermined slope, the airbag may not be deployed, and the false deployment of the airbag may be prevented.

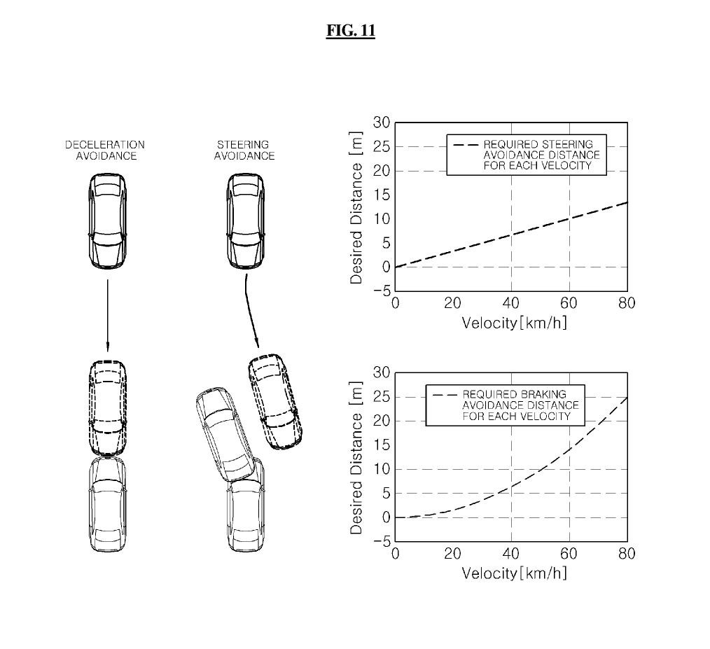

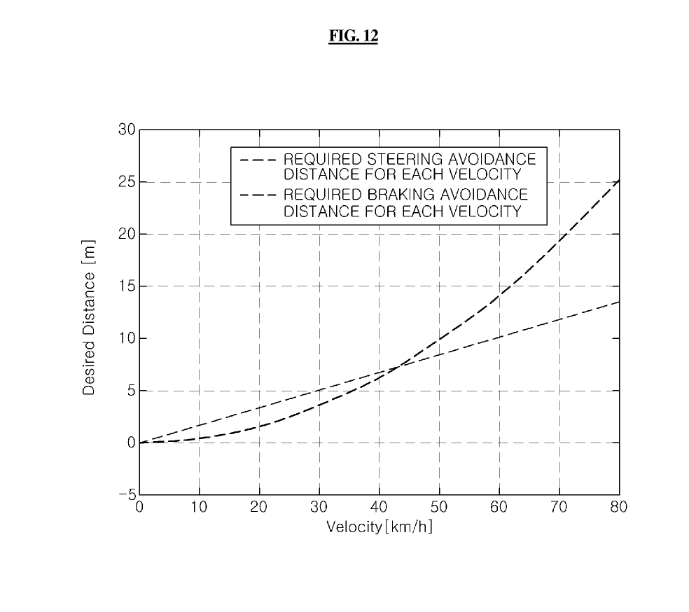

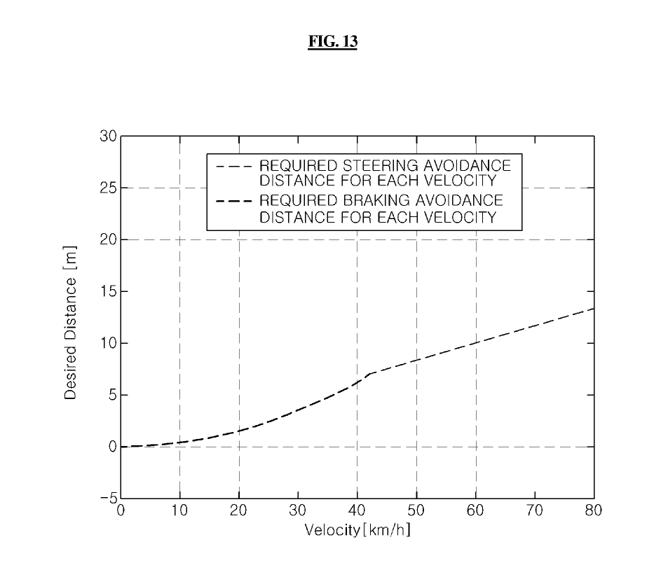

Moreover, when a distance between the vehicle and the target object is less than a required steering avoidance distance and a required braking avoidance distance, the external airbag can be deployed (that is, Point Of No Return: PONR may be calculated) at step S530 and S540. FIGS. 11 and 13 are exemplary diagrams showing the avoidance step of the external airbag deployment method according to an embodiment of the present invention. In the drawings, a vehicle can urgently avoid a collision using deceleration or steering, which may be represented by a relationship between a relative velocity and a relative distance.

Therefore, respective graphs for a required steering avoidance distance and a required braking avoidance distance versus a relative velocity overlap each other. A portion under a common denominator of the graphs, that is, the curve of the graph of FIG. 13, indicates that when braking or steering is sufficiently conducted, a collision may not be avoided. Thus, the airbag may be deployed.

The required braking avoidance distance may be represented by the following Equation (4):

$${d}_{braking} = \frac{{v}_{0}^{2} - {v}^{2}}{2 {a}_{x}} ( v = 0 , {a}_{x} = 1.0 g ) \qquad ( 4 )$$

This distance denotes a function of dividing a square of the relative velocity by twice the acceleration of gravity g.

Further, the required steering avoidance distance may be presented by the following Equation (5):

$${d}_{steering} = \sqrt{\frac{2 \cdot {o}_{i}}{{a}_{y}}} \cdot {v}_{rel} \\ {o}_{i} = current overlap amount \\ \sqrt{\frac{2 \cdot {o}_{i}}{{a}_{y}}} = time required to avoid current overlap amount ( {o}_{i} ) using {a}_{y} ( 1.0 g ) \qquad ( 5 )$$

The above equation 5 may calculate the required steering avoidance distance by dividing twice the current overlap amount by a lateral relative velocity, taking a square root of the divided result value, and multiplying the lateral relative velocity by the square root.

Moreover, after this procedure has been performed, the process may include validating, (S560), by the controller, the presence of the target object using an ultrasonic sensor to prevent sensor errors. Additionally, the process may include checking (S570), by the controller, whether communication and parts are operational, and deploying (S580), by the controller, the external airbag.

The external airbag deployment method according to the present invention will be summarized again below. First, a detection area may be set based on the deployment characteristics of an external airbag, thus reducing the burden of data processing by monitoring selected of data regarding actual objects. Further, data may be predicted and calculated during each measurement period of a sensor, to generate data at intervals of 1 ms. After dangerous objects have been selected based on a TIC and a TIE, a corresponding dangerous object may be selected as a target object based on a relative velocity, an overlap, and a TTE, thus specifying and continuously tracking the object in conformity with the actual collision situation of the vehicle.

Furthermore, even when an object is selected as a target object, the target object may be filtered based on a relative velocity and an overlap at a time TTC, thus preventing false deployment, and the target object may be filtered based on collision probability (CP), a variation in CP, vehicle stability, a required steering avoidance distance, and a required braking avoidance distance.

As described above, according to an external airbag deployment method having the above-described configuration, the present invention may predict and obtain the physical characteristics of objects at intervals of a unit time and determine whether to deploy an external airbag based on the predicted and obtained physical characteristics, thus enabling external airbag deployment even in a high-speed collision or a sudden collision. In particular, the physical characteristics may be measured at intervals of a unit time due to insufficiency of determining physical quantities measured by a front sensor only at intervals of the measurement period of the sensor. Further, the present invention may prevent false deployment

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An external airbag deployment method comprising:
setting, by a controller, a detection area located in front of a vehicle;
updating, by the controller, physical characteristics of a plurality of objects detected in the detection area at intervals of a measurement period of a front sensor;
calculating, by the controller, predicted physical characteristics at intervals of a unit time during each measurement period;
selecting, by the controller, a target object from the plurality of objects detected in the detection area by comparing a relative velocity, an overlap, and a Time To External Airbag (EAB)(TTE) calculated as the physical characteristics, wherein the TTE is a remaining time until each object collides with an airbag cushion when the external airbag is predicted to be deployed; and
deploying, by the controller, the external airbag when a relative velocity and an overlap, predicted at a time when the target object is predicted to collide with the vehicle, are greater than predetermined levels.

2. The external airbag deployment method of claim 1, wherein setting the detection area includes:
assigning, by the controller, Identifications (IDs) to respective detected objects; and
managing, by the controller, the detected objects.

3. The external airbag deployment method of claim 1, wherein the unit time is 1 ms.

4. The external airbag deployment method of claim 1, further comprising
calculating, by the controller, a physical characteristic at time i+1 using a tracking filter when measurement is performed at time i by the front sensor; and
calculating, by the controller, physical characteristics using previous physical characteristics during an interval from the time i+1 to a subsequent measurement period.

5. The external airbag deployment method of claim 1, further comprising:
calculating, by the controller, a displacement by adding a value, obtained by multiplying a unit time by a velocity previously obtained, to displacement previously obtained, upon calculating physical characteristics during an interval from time i+1 to a subsequent measurement period.

6. The external airbag deployment method of claim 1, further comprising:
calculating, by the controller, a velocity from a velocity previously obtained using an acceleration at time i, upon calculating physical characteristics during an interval from time i+1 to a subsequent measurement period.

7. The external airbag deployment method of claim 1, further comprising:
calculating, by the controller, a TTE, which is a remaining time until an object collides with an airbag cushion when the external airbag is predicted to be deployed, by dividing a value, obtained by subtracting a thickness of the airbag cushion from a relative distance at a corresponding time point, by a relative velocity at the corresponding time point, upon calculating physical characteristics during the interval from the time i+1 to the subsequent measurement period.

8. An external airbag deployment system, comprising:
a controller configured to:
set a detection area located in front of a vehicle;
update physical characteristics of a plurality of objects detected in the detection area at intervals of a measurement period of a front sensor;
calculate predicted physical characteristics at intervals of a unit time during each measurement period;
select a target object from the plurality of objects detected in the detection area by comparing a relative velocity, an overlap, and a Time To External Airbag (EAB)(TTE) calculated as the physical characteristics, wherein the TTE is a remaining time until each object collides with an airbag cushion when the external airbag is predicted to be deployed; and
deploy the external airbag when a relative velocity and an overlap, predicted at a time when the target object is predicted to collide with the vehicle, are greater than predetermined levels.

9. The system of claim 8, wherein the controller is further configured to:
assign Identifications (IDs) to respective detected objects; and
manage the detected objects.

10. The system of claim 8, wherein the controller is further configured to:
calculate a physical characteristic at time i+1 using a tracking filter when measurement is performed at time i by the front sensor; and
calculate physical characteristics using previous physical characteristics during an interval from the time i+1 to a subsequent measurement period.

11. The system of claim 8, wherein the controller is further configured to:
calculate a displacement by adding a value, obtained by multiplying a unit time by a velocity previously obtained, to displacement previously obtained, upon calculating physical characteristics during an interval from time i+1 to a subsequent measurement period.

12. The system of claim 8, wherein the controller is further configured to:
calculate a velocity from a velocity previously obtained using an acceleration at time i, upon calculating physical characteristics during an interval from time i+1 to a subsequent measurement period.

13. The system of claim 8, wherein the controller is further configured to:
calculate a TIE, which is a remaining time until an object collides with an airbag cushion when the external airbag is predicted to be deployed, by dividing a value, obtained by subtracting a thickness of the airbag cushion from a relative distance at a corresponding time point, by a relative velocity at the corresponding time point, upon calculating physical characteristics during the interval from the time i+1 to the subsequent measurement period.

14. The system of claim 8, wherein the unit time is 1 ms.

15. A non-transitory computer readable medium containing program instructions executed by a processor or controller, the computer readable medium comprising:
program instructions that set a detection area located in front of a vehicle;
program instructions that update physical characteristics of a plurality of objects detected in the detection area at intervals of a measurement period of a front sensor;
program instructions that calculate predicted physical characteristics at intervals of a unit time during each measurement period;
program instructions that select a target object from the plurality of objects detected in the detection area by comparing a relative velocity, an overlap, and a Time To External Airbag (EAB)(TTE) calculated as the physical characteristics, wherein the TIE is a remaining time until each object collides with an airbag cushion when the external airbag is predicted to be deployed; and
program instructions that deploy the external airbag when a relative velocity and an overlap, predicted at a time when the target object is predicted to collide with the vehicle, are greater than predetermined levels.

16. The non-transitory computer readable medium of claim 15, further comprising:
program instructions that calculate a physical characteristic at time i+1 using a tracking filter when measurement is performed at time i by the front sensor; and
program instructions that calculate physical characteristics using previous physical characteristics during an interval from the time i+1 to a subsequent measurement period.

17. The non-transitory computer readable medium of claim 15, further comprising:
program instructions that calculate a displacement by adding a value, obtained by multiplying a unit time by a velocity previously obtained, to displacement previously obtained, upon calculating physical characteristics during an interval from time i+1 to a subsequent measurement period.

18. The non-transitory computer readable medium of claim 15, further comprising:
program instructions that calculate a velocity from a velocity previously obtained using an acceleration at time i, upon calculating physical characteristics during an interval from time i+1 to a subsequent measurement period.

19. The non-transitory computer readable medium of claim 15, further comprising:
program instructions that calculate a TTE, which is a remaining time until an object collides with an airbag cushion when the external airbag is predicted to be deployed, by dividing a value, obtained by subtracting a thickness of the airbag cushion from a relative distance at a corresponding time point, by a relative velocity at the corresponding time point, upon calculating physical characteristics during the interval from the time i+1 to the subsequent measurement period.
